(19) United States
(12) Patent Application Publication
(10) Pub. No.: US 2024/0029144 A1
(43) Pub. Date: Jan. 25, 2024

(54) INTELLIGENT ELECTRONIC SHOPPING SYSTEM WITH SUPPORT FOR MULTIPLE ORDERS

(71) Applicant: Lee Cuthbert, Carlsbad, CA (US)

(72) Inventor: Lee Cuthbert, Carlsbad, CA (US)

(21) Appl. No.: 18/217,301

(22) Filed: Jun. 30, 2023

Related U.S. Application Data
(60) Provisional application No. 63/391,074, filed on Jul. 21, 2022.
(60) Provisional application No. 63/398,812, filed on Aug. 17, 2022.

(51) Int. Cl. G06Q 30/0601; G06Q 10/0631; B62B 3/14; G01G 23/36; G06V 10/764; G06V 20/50

(52) U.S. Cl. CPC G06Q 30/0635; G06Q 10/06316; G06Q 30/0639; B62B 3/1464; B62B 3/1468; G01G 23/36; G06V 10/764; G06V 20/50; G06K 7/1408

(57) ABSTRACT

While smart shopping carts can improve shopping experiences, they are expensive. Accordingly, an intelligent electronic shopping system is disclosed that enables any standard shopping cart to be converted into a smart shopping cart. Disclosed embodiments facilitate the fulfillment of multiple orders at once by personal shopper/delivery driver (PSDD) workers by providing, for example, order segregation, specific navigational instructions for a shopping trip, intelligent weighing systems, and/or easy checkout that avoids checkout lines.

### CROSS-REFERENCE TO RELATED APPLICATIONS

This application claims priority to U.S. Provisional Patent App. No. 63/391,074, filed on Jul. 21, 2022, and U.S. Provisional Patent App. No. 63/398,812, filed on Aug. 17, 2022, which are both hereby incorporated herein by reference as if set forth in full.

### BACKGROUND

### Field of the Invention

The embodiments described herein are generally directed to personal shopping or delivery in the gig economy, and, more particularly, to an intelligent electronic shopping system that facilitates the management of multiple orders during a single shopping trip by a personal shopper/delivery driver (PSDD).

### Description of the Related Art

A PSDD worker receives orders for items from consumers. These orders are generally dispatched through a platform, such as Instacart™, Uber Eats™, Door Dash™, Point Pickup™ Shipt™, or the like. The worker will receive each order via a software application on the worker's mobile device (e.g., smartphone). The software application may designate the merchant (e.g., retail store) at which the items in the order are to be purchased, or if the items in the order(s) are fungible (e.g., groceries), may leave it to the worker to determine the merchant. After receiving an order, the worker must visit the merchant, find each item in the order, place that item in a physical shopping cart, and pay for each item at checkout (e.g., in a manned checkout lane or self-checkout lane), prior to delivering the order to the consumer.

In some instances, different consumers may submit orders designating the same merchant or which can be fulfilled at the same merchant. In these instances, it is generally most efficient for all of the orders to be dispatched to a single worker. This enables a single worker to fulfill multiple orders in a single shopping trip. However, currently, such a worker would have to keep track of each discrete order during the shopping trip, as well as process each order separately at checkout. This is difficult, inefficient, time-consuming, and prone to human error, especially as the number of orders that must be simultaneously managed increases.

Thus, a merchant that facilitates the management of multiple orders may draw PSDD workers whose orders do not require a particular merchant (e.g., grocery orders). In a 2018 survey for grocery shopping, 50% of respondents cited the checkout experience as “very important,” and another 35% of respondents cited the checkout experience as “important.” In addition, the length of checkout lines was the part of the shopping experience with which respondents were least satisfied. Furthermore, three-quarters of respondents do not exclusively shop at any single grocery store, and long lines and poor checkout experiences were the third highest reason that respondents would go elsewhere. In other words, shoppers, including PSDD workers, want the shopping experience to be fast and easy, and are willing to take their business elsewhere for a fast and easy experience.

Streamlining the shopping experience, including checkout, can also have a positive effect on a merchant's bottom line. Such streamlining can increase throughput through the merchant's store, as well as reduce the staff hours required to process checkouts. This equates to both an increase in revenue and a decrease in expenses for the merchant.

### SUMMARY

Accordingly, an intelligent electronic shopping system is disclosed for facilitating the management of multiple orders during a single shopping trip.

In an embodiment, a system comprises: a plurality of partitions, wherein each of the plurality of partitions is configured to hold a plurality of items and be mounted in a basket of a shopping cart; one or more scanners, wherein each of the one or more scanners is configured to pair with a mobile device, determine an identifier of each of the plurality of items, and communicate the identifier of each respective item to the mobile device via the pairing.

Determining the identifier of each of the plurality of items may comprise, for each of the plurality of items: reading a machine-readable indicium on the item; and decoding the machine-readable indicium into an identifier of the item.

The system may further comprise an information system, wherein each of the one or more scanners is further configured to: receive information about each of the plurality of items from the information system; and communicate the information about the respective item, with the identifier of the respective item, to the mobile device via the pairing. The information about the respective item may comprise a price of the respective item.

Each of the one or more scanners may be configured to detachably attach to a frame of the shopping cart.

The system may further comprise a housing, wherein the housing comprises: a shelf configured to hold a mobile device; and a socket configured to hold at least one of the one or more scanners. The housing may further comprise a clamp configured to slide along a track, orthogonally to the shelf, to thereby clamp the mobile device between the shelf and the clamp.

The system may further comprise at least one intelligent weighing system, wherein the at least one intelligent weighing system is configured to: pair with the mobile device; weigh one or more of the plurality of items; and communicate the weight of the one or more items to the mobile device via the pairing between the intelligent weighing system and the mobile device. The at least one intelligent weighing system may comprise one or more portable intelligent weighing systems. Each of the one or more portable intelligent weighing systems may be configured to detachably attach to a frame of the shopping cart. The at least one intelligent weighing system may comprise a stationary intelligent weighing system, and the stationary intelligent weighing system may comprise a holding surface, configured to hold one or more of the plurality of items, and a computer vision system that is configured to: capture an image of the one or more items held on the holding surface; apply a classification model to the captured image to determine a class of the one or more items in the captured image; and communicate an identifier of the one or more items, derived from the determined class, to the mobile device via the pairing between the intelligent weighing system and the mobile device.

The system may further comprise a software application configured to, when executed by at least one hardware processor: receive a plurality of orders, to be fulfilled at a single merchant and dispatched to a single worker, via an ordering platform, wherein each of the plurality of orders comprises one or more of the plurality of items; receive a planogram of the merchant's store, wherein the planogram comprise a layout of the merchant's store and identifies locations of the items in the plurality of orders; plan a route through the merchant's store, based on the locations of the items in the plurality of orders, identified in the planogram, wherein the route comprise a sequence of waypoints in the merchant's store; generate a graphical user interface, for display on the mobile device, that routes the worker through the sequence of waypoints; and at each waypoint in the sequence of waypoints, for each item in the plurality of orders that is located at that waypoint, receive an identifier of the item, determine one of the plurality of orders with which the item is associated, and add the item to the determined order. The software application may comprise a client application, configured to execute on the mobile device. The software application may comprise a server application, configured to transmit the graphical user interface to the mobile device.

In an embodiment, a method comprises using at least one hardware processor to: receive a plurality of orders, for a single merchant and dispatched to a single worker, via an ordering platform, wherein each of the plurality of orders comprises one or more items; receive a layout of the merchant's store, wherein the layout identifies locations of the items in the plurality of orders; plan a route through the merchant's store, based on the locations of the items in the plurality of orders, wherein the route comprise a sequence of waypoints in the merchant's store; generate a graphical user interface, for display on a mobile device, that routes the worker through the sequence of waypoints; and at each waypoint in the sequence of waypoints, for each item in the plurality of orders that is located at that waypoint, receive an identifier of the item, determine one of the plurality of orders with which the item is associated, and add the item to the determined order.

The identifier of at least one item may be received from an external scanner.

The identifier of at least one item may be received from an intelligent weighing system. The method may further comprise using the at least one hardware processor to receive a weight of at least one item from an intelligent weighing system.

The graphical user interface may display a representation of each of the plurality of orders, wherein each representation of a respective one of the plurality of orders is color-coded with a different color than any other ones of the plurality of orders.

The method may further comprise using the at least one hardware processor to perform a checkout for all of the plurality of orders.

It should be understood that any of the features above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever.

### BRIEF DESCRIPTION OF THE DRAWINGS

The details of the present invention, both as to its structure and operation, may be gleaned in part by study of the accompanying drawings, in which like reference numerals refer to like parts, and in which:

FIGS. 1A and 1B illustrate an intelligent electronic shopping system, according to an embodiment;

FIG. 2 illustrates an intelligent weighing system that may be used in the intelligent electronic shopping system, according to an embodiment;

FIG. 3 illustrates a housing for components of an intelligent electronic shopping system, according to an embodiment;

FIG. 4 illustrates an example processing system by which one or more of the processes described herein may be executed, according to an embodiment; and

FIG. 5 illustrates an example process that utilizes the intelligent electronic shopping system, according to an embodiment.

### DETAILED DESCRIPTION

In an embodiment, an intelligent electronic shopping system is disclosed for facilitating the management of multiple orders during a single shopping trip. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

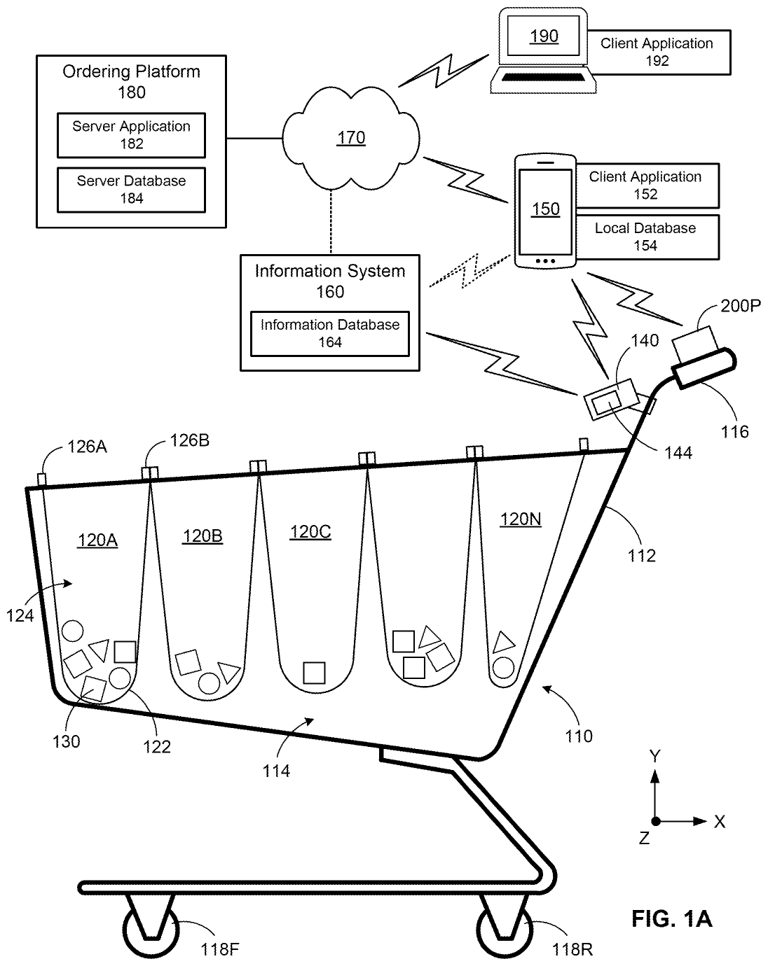

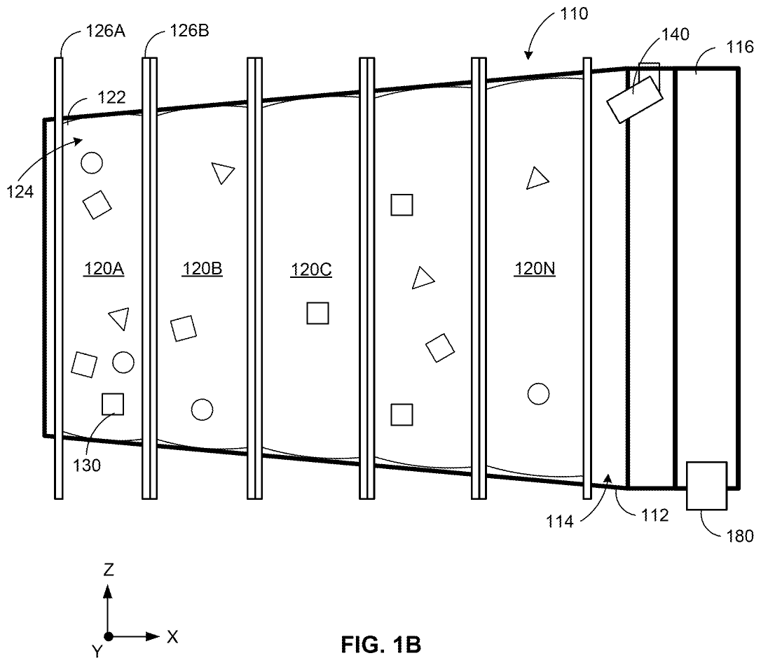

FIG. 1A illustrates an intelligent electronic shopping system, according to an embodiment. The intelligent electronic shopping system may utilize a standard shopping cart 110, such as those typically found in retail stores. Such a shopping cart 110 generally comprises a frame 112 forming a cart basket 114, into which items can be stowed. Frame 112 may comprise a handle 116 on one end, and four wheels 118 (e.g., casters), including a pair of front wheels 118F and a pair of rear wheels 118R, such that shopping cart 110 can be pushed or pulled by handle 116 or another component of frame 112. In an embodiment, the intelligent electronic shopping system is configured to work with a variety of different shopping carts 110, for example, having different dimensions, shapes, and/or the like. While shopping cart 110 is illustrated as having wheels 118, such that shopping cart 110 is able to be pushed, in an alternative embodiment, shopping cart 110 may be designed as a basket without wheels 118, which is carried by a handle 116.

The intelligent electronic shopping system may comprise a set of one or more partitions 120, illustrated as a plurality of partitions 120A, 120B, . . . , 120N. Each partition 120 may comprise a bag 122, suspended between a pair of rods 126A and 126B, to form a partition basket 124. Bag 122 may be made of any suitable material, including fabric, plastic, paper, and/or the like. Similarly, rods 126 may be made of any suitable material, including plastic, metal, wood, and/or the like. In an embodiment, the length of rods 126 may be adjustable. It should be understood that this is simply one, non-limiting example of how a partition 120 may be constructed. Any of various other suitable designs may be used instead, as long as each partition 120 comprises a partition basket 124 into which items 130 may be stowed. More generally, each partition 120 is configured to hold a plurality of items 130 and be mounted in a cart basket 114 of a shopping cart 110. Each partition 120 and its respective partition basket 124 may be dedicated to a single discrete order.

A worker may utilize any number of partitions 120 during a given shopping trip at a merchant's store. Each partition 120 may be independent from all of the other partitions 120, such that the worker can easily construct a system consisting of any number of partitions 120, limited only by the amount of space within cart basket 114. As illustrated, each partition 120 may be placed adjacent to one or more other partitions 120. Rods 126 could interlock, such that partitions 120 could be releasably fixed to an adjacent partition 120 via rods 126. For example, rod 126A of a first partition 120 (e.g., 120B) could interlock with a rod 126B of an adjacent second partition 120 (e.g., 120A) on one side, and rod 126B of the first partition 120 could interlock with a rod 126A of an adjacent third partition 120 (e.g., 120C) on the opposite side. However, an interlocking mechanism is not a necessity of any embodiment.

It should be understood that the number of partitions 120 that a worker utilizes may correspond to the number of orders that the worker is attempting to complete during a given shopping trip. For example, if the worker has one order, the worker may utilize only a single partition 120, or may simply utilize cart basket 114 without any partitions 120. On the other hand, if the worker has two orders, the worker may utilize two partitions 120; if the worker has three orders, the worker may utilize three partitions 120; if the worker has four orders, the worker may utilize four partitions 120; and so on and so forth. Partitions 120 serve to partition or segregate the items 130 in each order, such that the worker can easily keep each order separate during the shopping trip. In other word, each partition 120 is associated with a particular one of the orders, and the worker adds items 130 in an order only to the partition 120 associated with that order.

Each partition 120 may be foldable, such that a partition 120 may be collapsed when not in use and expanded when in use. Alternatively, each partition 120 may be a basket with a fixed size. Each partition 120 may be colored differently from one or more other partitions 120, such that a set of color-coded partitions can be constructed, wherein each partition 120 has a different color than all other partitions 120 in the set and can be associated with a respective order, which may be correspondingly color-coded in a graphical user interface.

It is generally contemplated that partitions 120 would be owned by the worker and useable with any standard shopping cart 110. Thus, the worker may construct the set of partitions 120 when arriving at a merchant's store and deconstruct the set of partitions when leaving the merchant's store. In other words, partitions 120 may be reused by the worker on each shopping trip, regardless of the merchant, including the particular design of shopping carts 110 used by the merchant. However, in an alternative embodiment, each partition 120 may be disposable or given to the consumer upon delivery of an order. In this case, each partition 120 should be designed to be inexpensive, so that the worker can easily replenish the worker's supply of partitions 120 for new orders. In yet another embodiment, each merchant may supply partitions 120. In this case, partitions 120 could be permanently built into shopping carts 110, and/or the merchant may set aside a subset of shopping carts 110 with inserted partitions 120 for use by PSDD workers.

The intelligent electronic shopping system may also comprise one or more scanners 140. Each scanner 140 may comprise a wand or other system that reads machine-readable indicia on items 130 (e.g., printed on packaging of item 130, printed on a sticker adhered to the packaging of item 130, etc.) using a laser. Alternatively, scanner 140 may comprise an imaging device, such as a camera or other optical device, that is able to capture and decode images of the machine-readable indicia. More generally, scanner 140 may comprise any system that is capable of reading a machine-readable indicium. Each machine-readable indicium may comprise a barcode, which encodes a universal product code (UPC) or other identifier of an item 130. The barcode may be a one-dimensional barcode or a two-dimensional matrix barcode, such as a Quick Response (QR) code. It should be understood that any type of machine-readable indicia may be used to encode the identifier of an item 130. A machine-readable indicium may also encode additional information about an item 130 (i.e., in addition to the identifier of item 130), such as a name of item 130, a description of item 130, a name or other identifier of a manufacturer of item 130, and/or the like.

In an alternative embodiment, scanner 140 may utilize computer vision to identify items 130 without the necessity of machine-readable indicia. In this case, each scanner 140 may comprise a camera or other imaging device that captures an image of each item 130 before or as the worker is placing the item 130 into a partition 120. Scanner 140 may be configured to classify the item 130 in each image. In particular, scanner 140 may execute or interface with a machine-learning model or other classification model that has been trained to classify objects (i.e., items 130) in the images into one of a plurality of possible classes. The classes may be selected to encompass every type of item 130 within the merchant's store. For example, there may be a class for every UPC in the merchant's store. The classification model may be trained using supervised learning that utilizes a labeled training dataset. The labeled training dataset may comprise images of each class of item 130, with each image labeled with the ground-truth class of item 130 in that image. The training dataset should comprise images of each item 130 from different sides and/or angles, such that an item 130 can be detected in an image, regardless of how item 130 is oriented.

The classification model may output a probability value that the item 130 in an image belongs to each of the plurality of possible classes. If the probability value for any class satisfies (e.g., exceeds) a predefined threshold, scanner 140 may automatically detect that class as the identifier of item 130 or derive an identifier (e.g., UPC) of item 130 from the detected class. If none of the classes have a probability value that satisfies the predefined threshold, scanner 140 may determine that the identifier of item 130 is undefined. When an identifier of item 130 is undefined, the worker may be required to manually identify item 130.

In yet another alternative embodiment, scanner 140 may utilize radio-frequency identification (RFID) to identify items 130. For example, scanner 140 may comprise an RFID interrogator, and each item 130 may comprise an RFID tag. Each RFID tag may be a passive RFID tag, which is powered by electromagnetic waves, emitted by the RFID interrogator, that induce a magnetic field in an integrated antenna within the RFID tag. The RFID tag on each item 130 may transmit a UPC or other identifier when powered. This identifier may be received by an antenna in the RFID interrogator of scanner 140 and used as the identifier of item 130. The range of the RFID interrogator of scanner 140 may be set to a short range that only encompasses an area within 1-2 meters of scanner 140 and/or the area of cart basket 114.

Scanner 140 may be fastened to frame 112 (e.g., at or near handle 116) of shopping cart 110. In a preferred embodiment, the fastening means is easily reversible, such that scanner 140 may be quickly attached to and detached from frame 112. In other words, scanner 140 is configured to detachably attach to frame 112 of shopping cart 110. For example, scanner 140 may comprise a spring-loaded clip that clips to frame 112. However, any suitable fastening means may be used, including, for example, magnets, screws, bolts, and/or the like. In an alternative embodiment, scanner 140 is permanently affixed to frame 112 of shopping cart 110.

In an embodiment in which scanner 140 utilizes computer vision to identify items 130, scanner 140 may be fastened to frame 112 at a position at which the camera of scanner 140 has a view of all of partitions 120 mounted in cart basket 114. In this case, scanner 140 may automatically identify each item 130 as the worker places that item 130 into a particular partition 120. In addition, scanner 140 may also automatically detect the particular partition 120 into which the identified item 130 is being placed, such that the identified item 130 can be automatically associated with the order that is associated with the detected partition 120. In this case, the worker may associate each partition 120 with a particular order at the beginning of a shopping trip. Scanner 140 may differentiate partitions 120A-120N based on distance from the camera lens, machine-readable indicia on rods 126, signal strengths of RFID tags integrated into partitions 120, and/or the like.

Scanner 140 may be paired with a mobile device 150 of the worker, using, for example, a short-range (e.g., up to 10 meters) wireless technology, such as Bluetooth™, Zigbee™, or the like, a mid-range (e.g., 20 meters or more) wireless technology, such as Wi-Fi™, or a long-range wireless technology, such as any available cellular communication technology. Scanner 140 may determine an identifier of each item 130 that is acquired by the worker (e.g., scanned and/or placed in a partition 130), and communicate the identifier of each respective item 130 to mobile device 150 via the pairing between scanner 140 and mobile device 150. In particular, scanner 140 may communicate the identifier of each item 130 to a client application 152 executing on the paired mobile device 150. For example, in an embodiment in which machine-readable indicia are used, scanner 140 may read the machine-readable indicium on item 130, decode the machine-readable indicium into information, including the identifier of item 130, and communicate the decoded information to client application 152. In an embodiment in which computer vision is used, scanner 140 may detect the class of item 130, based on an image of item 130 captured by the camera of scanner 140, and communicate an identifier of item 130, derived from the detected class, to client application 152. In an embodiment in which RFID is used, scanner 140 may receive the identifier of item 130, transmitted by an RFID tag on item 130, and communicate the received identifier, or another identifier derived from the received identifier, to client application 152.

Scanner 140 may communicate with an information system 160, which may exist at least partially within the merchant's store. This communication may be wireless using, for example, Wi-Fi™ or the like, in which case the communication may be periodic (e.g., once a day, half a day, every hour, etc.) or continual or continuous (e.g., in real time). Alternatively, the communication may use a wired connection (e.g., Universal Serial Bus (USB) connection), in which case the communication may occur periodically (e.g., once a day), whenever scanner 140 is communicatively connected to information system 160.

Scanner 140 may retrieve or otherwise receive information about items 130, such as the current price of each item 130, from information system 160. The received information may be stored in a local database 144 of scanner 140. The information may be indexed by an identifier (e.g., UPC) of each item 130. Thus, as scanner 140 identifies each item 130 (e.g., using a machine-readable indicium, computer vision, RFID, etc.), the identifier may be used to retrieve additional information about the item 130 from local database 144. Then, the additional information about item 130 (e.g., current price of item 130), with the identifier of item 130, may be communicated to client application 152 of mobile device 150 via the pairing between scanner 140 and mobile device 150. In an alternative embodiment, scanner 140 could retrieve the additional information from information system 160, in real time, as items 130 are identified. It should be understood that, as used herein, the term “real time” or “real-time” includes events that occur simultaneously, as well as events that are separated in time due to ordinary latencies in processing, communications, storage access, and/or the like.

Information system 160 may comprise a server or base station that stores the information about each item 130, in association with the identifiers (e.g., UPC) for those items 130, in an information database 164. For wireless communication, information system 160 may comprise a router, and potentially one or more relays or range extenders to strengthen a signal throughout the merchant's store, which provide a local area network (LAN) to which each scanner 140 may connect. Scanners 140 may pull the information from information database 164 through an application programming interface (API) of information system 160. In a particular implementation, information system 160 may be operated by someone other than the merchant. In this case, the merchant may periodically (e.g., once a day) download the information about items 130 to information system 160, or information system 160 may periodically (e.g., once a day) pull the information about items 130 from a merchant's system. It should be understood that the information stored in information database 164 may be continually updated to at least always reflect the current price of each item 130.

It is generally contemplated that mobile device 150 will be the worker's smartphone. However, mobile device 150 may be another type of portable processing device, including a tablet computer, laptop computer, or the like. Mobile device 150 executes a client application 152 that communicates, via a network 170, with an ordering platform 180. In particular, client application 152 communicates with a server application 182, executing on ordering platform 180. Data required by client application 152, including, for example, information received from scanner 140, may be stored in a local database 154 on mobile device 150. Client application 152 may be a mobile “app” that is downloaded from an online app store or other site, and installed on mobile device 150. In this case, client application 152 may be free to download and use, require purchase to download and use, be free to download but require a monthly subscription fee to use, or the like.

In an alternative embodiment, mobile device 150 may perform the functions of scanner 140. In other words, scanner 140 may be omitted. In this case, mobile device 150 may comprise a camera or other device capable of reading machine-readable indicia and/or performing computer vision, and/or an RFID interrogator capable of reading RFID tags. In addition, client application 152 may communicate with information system 160 directly (e.g., via Wi-Fi™) or via network 170, to pull information about each item 130 from information system 160 (e.g., periodically or in real time), and optionally store that information in local database 154. Client application 152 may identify each item 130, in an identical or similar manner as described elsewhere herein with respect to scanner 140, and use the identifier to retrieve additional information (e.g., current price) about the item 130 from information database 164 or local database 154.

Ordering platform 180 may comprise one or more servers which host and/or execute server application 182 for receiving orders from consumers and dispatching those orders to workers. Examples of ordering platform 180 include, without limitation, those operated by Instacart™, Uber Eats™, Door Dash™, Point Pickup™, Shipt™, and the like. Ordering platform 180 may comprise dedicated servers, or may instead be implemented in a computing cloud, in which the resources of one or more servers are dynamically and elastically allocated to multiple tenants based on demand. In either case, the servers may be collocated and/or geographically distributed.

Although only one mobile device 150 is illustrated, it should be understood that ordering platform 180 may be communicatively connected to a plurality of mobile device 150 via network 170. Each mobile device 150 may correspond to a respective worker. In addition, ordering platform 180 may be communicatively connected to a plurality of user systems 190 via network 170. A user system 190 may comprise any processing device capable of wired and/or wireless communication, including without limitation, desktop computers, laptop computers, tablet computers, smartphones or other mobile phones, servers, game consoles, televisions, set-top boxes, electronic kiosks, point-of-sale terminals, and/or the like. Each user system 190 may correspond to a respective consumer.

A consumer will utilize a client application 192 on a respective user system 190 to place an order of one or more items 130 from a merchant. This order will be received by ordering platform 180, which will dispatch the order to a worker via client application 152 on mobile device 150 of the worker. For increased efficiency, when multiple orders are received from a plurality of consumers for the same merchant, or for items 130 that may be purchased from the same merchant, around the same time, these orders may be batched together and dispatched to the same worker. The worker may utilize the disclosed intelligent electronic shopping system to purchase all of the items 130 for all of the orders at the merchant, while keeping each order separate from the other orders during the shopping trip and through checkout, before delivering the orders to their respective consumers.

In an embodiment, client application 192, used by consumers, may be the same as client application 152, used by workers, but operating in a different mode or according to a different role than client application 152 (e.g., a consumer role vs. a worker role). In some instances, a user could be both a consumer and a worker, in which case mobile device 150 and user system 190 may be one in the same for that user. For example, the user could use a smartphone as mobile device 150 when acting as a worker, and use the same smartphone as user system 190 when acting as a consumer. In this case, a client application, executing on the user's smartphone, may act as client application 152 when the user is acting as a worker and act as client application 192 when the user is acting as a consumer.

Network 170 may comprise the Internet. Ordering platform 180 may communicate with mobile devices 150, user system 190, and/or potentially information system 160 (e.g., to obtain product information, out-of-stock information, etc.), through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. Network 170 may comprise multiple networks, and the particular networks used may depend on the participants to a communication. For example, in the case of mobile device 150, network 170 may comprise a wireless communication network (e.g., cellular network, Wi-Fi™ network, etc.), in addition to the Internet. In the case of user system 190 or information system 160, network 170 may comprise a wireless communication network or local area network (LAN), in addition to the Internet.

Ordering platform 180 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 180 transmits or serves one or more screens of the graphical user interface in response to requests from client applications 152 and 192. In some embodiments, these screens may be served in the form of a wizard, in which case two or more screens may be served in a sequential manner, and one or more of the sequential screens may depend on an interaction of the with one or more preceding screens. The requests to ordering platform 180 and the responses from ordering platform 180, including the screens of the graphical user interface, may both be communicated through network 170, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in server database 184.

Ordering platform 180 may comprise a server database 184. For example, ordering platform 180 may comprise one or more database servers that manage database 184. Server application 182 executing on ordering platform 180, client application 152 executing on mobile device 150, client application 192 executing on user system 190, and/or information system 160 may submit data (e.g., user data, form data, etc.) to be stored in server database 184, and/or request access to data stored in server database 184. Any suitable database may be utilized, including without limitation MySQL™, Oracle™, IBM™, Microsoft SQL™, Access™, PostgreSQL™ MongoDB™, and the like, including cloud-based databases and proprietary databases. Data may be sent to ordering platform 180, for instance, using the well-known POST request supported by HTTP. These data, as well as other requests, may be handled, for example, by server-side web technology, such as a servlet or other software module (e.g., comprised in server application 182), executed by ordering platform 180.

In embodiments in which a web service is provided, ordering platform 180 may receive requests from client applications 152 and/or 192 and/or information system 160, and provide responses in eXtensible Markup Language (XML), JavaScript Object Notation (JSON), and/or any other suitable or desired format. In such embodiments, ordering platform 180 may provide an API which defines the manner in which client applications 152 and/or 192 and/or information system 160 may interact with the web service. Thus, client applications 152 and/or 192 and/or information system 160 can define their own user interfaces, and rely on the web service to implement or otherwise provide the backend processes, methods, functionality, storage, and/or the like, described herein. For example, in such an embodiment, client application 152 and/or 192 and/or information system 160 may interact with server application 182, executing on ordering platform 180, to perform one or more or a portion of one or more of the various functions or other processes described herein.

Client application 152 and/or 192 may be “thin,” in which case processing is primarily carried out server-side by server application 182 on ordering platform 180. A basic example of a thin client application is a browser application, which simply requests, receives, and renders a graphical user interface (e.g., webpages) at mobile device 150 or user system 190, while server application 182 on ordering platform 180 is responsible for generating and transmitting the graphical user interface to mobile device 150 or user system 190 and managing database functions. Alternatively, the client application may be “thick,” in which case processing is primarily carried out client-side by mobile device 150 or user system 190. It should be understood that client application 152 and/or 192 may perform an amount of processing, relative to server application 182 on ordering platform 180, at any point along this spectrum between “thin” and “thick,” depending on the design goals of the particular implementation. In any case, the software described herein, which may wholly reside on either ordering platform 180 (e.g., in which case server application 182 performs all processing) or mobile device 150 or user system 190 (e.g., in which case client application 152 or 192 performs all processing) or be distributed between ordering platform 180 and mobile device 150 and/or user system 190 (e.g., in which case server application 182 and client application 152 or 192 both perform processing), can comprise one or more executable software modules comprising instructions that implement one or more of the processes described herein. As used herein, the term “software application” will be used to refer to any set of software modules that perform the disclosed processes, whether those software modules reside entirely in server application 182, reside entirely in client application 152 and/or 192, or are distributed between server application 182 and client application 152 and/or 192.

The intelligent electronic shopping system may also comprise an intelligent weighing system 200. In the illustrated embodiment, intelligent weighing system 200 is a portable intelligent weighing system 200P. Portable intelligent weighing system 200P may be fastened to frame 112 (e.g., at or near handle 116) of shopping cart 110. In a preferred embodiment, the fastening means is easily reversible, such that portable intelligent weighing system 200P may be quickly attached to and detached from frame 112. In other words, portable intelligent weighing system 200P is configured to detachably attach to frame 112 of shopping cart 110. For example, portable intelligent weighing system 200P may comprise a spring-loaded clip that clips to frame 112. However, any suitable fastening means may be used, including, for example, magnets, screws, bolts, and/or the like.

Portable intelligent weighing system 200P may utilize any suitable mechanism to weigh items 130. For example, portable intelligent weighing system 200P may comprise a pan or other holding surface on the top that is configured to hold items 130, a hook from which items 130 may be hung, and/or the like. Mechanisms for weighing items 130 are well known in the art, and therefore, will not be described in detail herein.

Portable intelligent weighing system 200P may be paired with a mobile device 150 of the worker, using, for example, a short-range wireless technology (e.g., Bluetooth™, Zigbee™ etc.), mid-range wireless technology (e.g., Wi-Fi™), or long-range wireless technology (e.g., cellular communication technology). When one or more items 130 are weighed using portable intelligent weighing system 200P, portable intelligent weighing system 200P may communicate that weight to client application 152 executing on mobile device 150. Using this weight, in combination with a price per weight of item 130 (e.g., received by client application 152 from scanner 140 or information system 160), client application 152 can accurately calculate the cost of the weighed item(s) 130. In other words, portable intelligent weighing system 200P is configured to pair with mobile device 150, weigh item(s) 130, and communicate the weight of the item(s) 130 to mobile device 150 via the pairing between portably intelligent weighing system 200P and mobile device 150.

In an alternative embodiment, portable intelligent weighing system 200P may be paired with a scanner 140, using, for example, a short-range wireless technology, mid-range wireless technology, or long-range wireless technology. In this case, portable intelligent weighing system 200P may be configured to pair with scanner 140, weigh item(s) 130, and communicate the weight of the item(s) 130 to scanner 140 via the pairing between portably intelligent weighing system 200P and scanner 140. Scanner 140 may then communicate this weight to client application 152 or calculate the cost of weighted item(s) 130 and communicate this cost to client application 152, via the pairing between scanner 140 and mobile device 150.

In an embodiment, the intelligent electronic shopping system, which may comprise one or a plurality of partitions 120, a scanner 140, mobile device 150, and/or an intelligent weighing system 200, may not be preassembled by the merchant. For example, a worker may bring partition(s) 120 and mobile device 150 into the merchant's store, select a scanner 140 and/or portable intelligent weighing system 200P from a fixed location within the merchant's store, as discussed elsewhere herein, select a standard shopping cart 110 that is provided by the merchant, and attach partition(s) 120, the selected scanner 140, and/or the selected portable intelligent weighing system 200P to the selected shopping cart 110. The worker may also pair mobile device 150 with scanner 140 and/or portable intelligent weighing system 200P. Once, the worker has fulfilled the order, the worker may detach and return the scanner 140 and/or portable intelligent weighing system 200P to the fixed location, remove the partition(s) 120, and leave shopping cart 110 in a return stall.

FIG. 1B illustrates a top-down view of components of an intelligent electronic shopping system, according to an embodiment. As illustrated, each rod 126 may span the width (i.e., along the Z-axis) of frame 112 of shopping cart 110, such that each rod 126 is supported by the top edges of frame 112 above cart basket 114. Each bag 122 is fixed to rod 126A on one side and rod 126B on the opposite side, such that bag 122 hangs from rods 126 into cart basket 114 to form a partition basket 124. The length of rods 126 (i.e., along the Z-axis) may be sized to be at least slightly greater than the maximum width among all standard shopping carts 110, or the length of each rod 126 may be adjustable between a range of lengths (e.g., similar to a shower rod) representing the variation in widths of standard shopping carts 110, such that partition 120 can be used with any standard shopping cart 110. When not in use, each partition 120 may be collapsed or closed by bringing rod 126B into close proximity with rod 126A (e.g., along the X-axis). Thus, partitions 120 can be easily collapsed and stored (e.g., in the trunk of the worker's vehicle) when not in use. Although not shown, each partition 120 may comprise handles (e.g., a handle extending from the top surface or integrated into each rod 126) to enable partitions 120 to be easily carried.

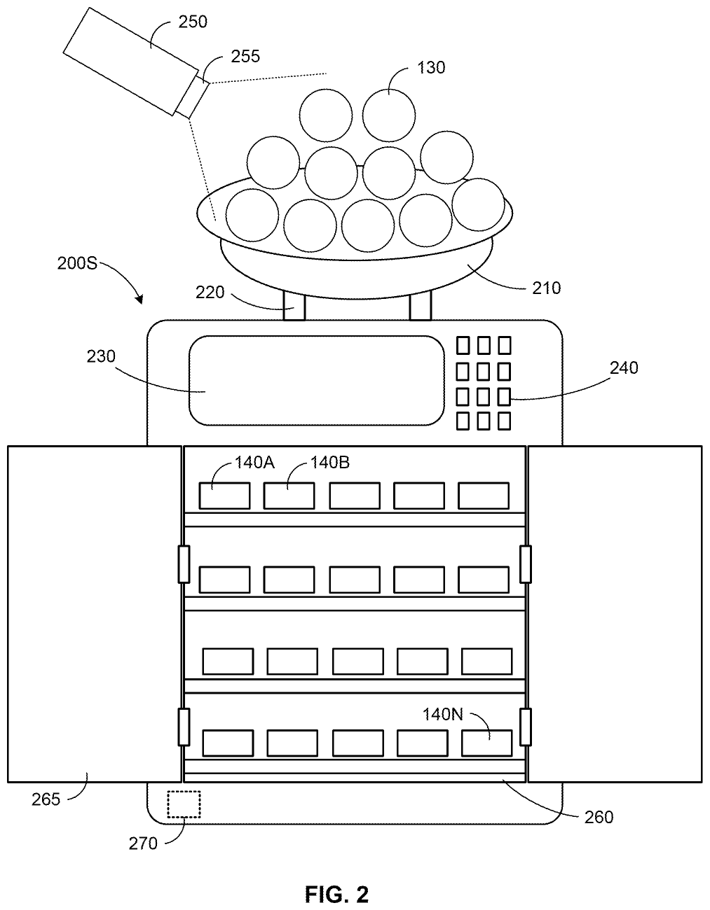

FIG. 2 illustrates a stationary intelligent weighing system 200S that may be used in the intelligent electronic shopping system, according to an embodiment. Stationary intelligent weighing system 200S may be used instead of or in addition to portable intelligent weighing systems 200P. For instance, instead of each worker having to utilize a discrete portable intelligent weighing system 200P, all workers may utilize the same stationary intelligent weighing system(s) 200S. In this case, a stationary intelligent weighing system 200S may be located in an area of the merchant's store in which weighing is frequently required, such as the fresh produce section of a grocery store.

Stationary intelligent weighing system 200S may comprise a pan or other holding surface 210 on the top that is configured to hold items 130. As items 130 are placed on holding surface 210, holding surface 210 presses down on connectors 220, which are connected to an electronic weighing module (not shown). The electronic weighing module calculates the weight of items 130 on holding surface 210 using well-known mechanisms.

The calculated weight and/or other information may be displayed on a display 230. In addition, one or more inputs 240 (e.g., keypad or keyboard) may be provided, so that a worker can interact with stationary intelligent weighing system 200S. In an alternative embodiment, display 230 and inputs 240 may be combined into a single touch-panel display that both displays information and receives inputs via virtual buttons.

As with portable intelligent weighing system 200P, stationary intelligent weighing system 200S may be paired with a mobile device 150 of the worker or a scanner 140 being used by the worker. When the weight of one or more items 130 are calculated by the electronic weighing module, stationary intelligent weighing system 200S may communicate that weight to client application 152 executing on mobile device 150. Using this weight, in combination with a price per weight of item 130 (e.g., received by client application 152 from scanner 140 or information system 160), client application 152 can accurately calculate the cost of the weighed item(s) 130. Alternatively, in an embodiment in which stationary intelligent weighing system 200S is paired with scanner 140, stationary intelligent weighing system 200S may communicate the weight to scanner 140, which may relay the weigh to client application 152, or calculate the cost of the weighed item(s) 130 and communicate this cost to client application 152.

Each worker may pair a respective mobile device 150 or scanner 140 with stationary intelligent weighing system 200S (e.g., using input(s) 240, client application 152, input(s) on scanner 140, etc.) at the start of weighing item(s) 130. Once the worker is done, the worker may unpair the mobile device 150 or scanner 140 from stationary intelligent weighing system 200S (e.g., using input(s) 240, client application 152, input(s) on scanner 140, etc.). Alternatively or additionally, the pairing may timeout (e.g., after a predefined time period) or may automatically end when mobile device 150 or scanner 140 exits a wireless range of stationary intelligent weighing system 200S.

In an embodiment, stationary intelligent weighing system 200S comprises a computer vision system 250. Computer vision system 250 may comprise a camera 255 or other imaging device that is oriented to have a field of view of holding surface 210. In particular, camera 255 may be positioned to capture an image of all items 130 on holding surface 210, as the weight of those items 130 are calculated by the electronic weighing module.

Computer vision system 250 may be configured to classify the item 130 on holding surface 210. In particular, computer vision system 250 may execute a machine-learning model or other classification model that has been trained to classify objects (i.e., items 130) in the images, captured by camera 255, into one of a plurality of possible classes. The classes may be selected to encompass every type of item 130 for which the price is calculated by weight. For example, for a grocery store, the plurality of possible classes may include different types of fresh produce (e.g., fruits, vegetables, etc.) that are sold by weight by the grocery store, such as strawberries, blueberries, oranges, onions, and the like. A typical grocery store offers approximately two-hundred different produce items 130, which means that there will be approximately two-hundred possible classes. The classification model may be trained using supervised learning that utilizes a labeled training dataset. The labeled training dataset may comprise images of each class of item 130, with each image labeled with the ground-truth class of item 130 in that image.

The classification model may output a probability value that the item(s) 130 on holding surface 210 belong to each of the plurality of possible classes. If the probability value for any class satisfies (e.g., exceeds) a predefined threshold, computer vision system 250 may automatically detect that class as the identifier of item(s) 130. This identifier, along with the calculated weight of item(s) 130, may be communicated to client application 152 via a pairing between mobile device 150 and stationary intelligent weighing system 200S or to scanner 140 via a pairing between scanner 140 and stationary intelligent weighing system 200S, so that item(s) 130 may be automatically identified and the price for item(s) 130 may be automatically calculated based on the weight and the identity of item(s) 130. Thus, the worker does not need to manually identify the weighed item(s) 130. In addition, stationary intelligent weighing system 200S may display the identity of the item(s) 130 on display 230. If the classification is incorrect, the worker may manually adjust the identity of item(s) 130 either via input(s) 240 and/or via the graphical user interface of client application 152.

If none of the classes have a probability value that satisfies the predefined threshold, stationary intelligent weighing system 200S may indicate this to client application 152 or scanner 140, along with the weight. In this case, client application 152 may prompt the worker to manually identify the item(s) 130 via the graphical user interface, so that the price may be calculated based on the weight communicated by stationary intelligent weighing system 200S. Alternatively or additionally, stationary intelligent weighing system 200S may prompt the worker to manually identify the item(s) 130 via input(s) 240.

In an embodiment, when weighed item(s) 130 may be visually identical or similar, but possess one or more different characteristics that affect pricing, stationary intelligent weighing system 200S or client application 152 may prompt the worker to identify the applicable characteristic(s). For example, some produce may be offered in both organic and non-organic varieties, with organic varieties being priced higher. In this case, stationary intelligent weighing system 200S or client application 152 may prompt the worker to select whether or not the produce that was weighed as item(s) 130 is organic or non-organic.

In summary, computer vision system 250 may capture an image of one or more items 130 on holding surface 210 via camera 255. Computer vision system 250 may apply a classification model to the captured image to determine a class of item(s) 130 in the captured image. Then, stationary intelligent weighing systems 200S may communicate an identifier of item(s) 130, derived from the determined class, to mobile device 150 (e.g., to client application 152), along with a weight, quantity, and/or cost of item(s) 130, directly via a pairing between stationary intelligent weighing systems 200S and mobile device 150 or indirectly via a pairing between stationary intelligent weighing systems 200S and scanner 140.

In an alternative embodiment in which computer vision system 250 is omitted, stationary intelligent weighing system 200S may rely on the worker to identify the item(s) 130 being weighed. For example, stationary intelligent weighing system 200S may prompt the worker to identify the item(s) 130 being weighed via display 230. The worker may then input the identity of the item(s) 130 being weighed via input(s) 240.

It should be understood that computer vision system 250 may not be necessary if the weighed item(s) 130 can be identified by scanner 140. For example, some produce may have or be associated with a machine-readable indicium that can be scanned by scanner 140. Thus, scanner 140 identifies item(s) 130 and stationary intelligent weighing system 200S determines the weight of the identified item(s) 130.

In an embodiment in which stationary intelligent weighing systems 200S is paired with mobile device 150 and is capable of identifying item(s) 130, either via computer vision system 250 or manual input, scanner 140 could be omitted, at least with respect to item(s) 130 that need to be weighed. In this case, stationary intelligent weighing systems 200S may communicate with information system 160, via wired or wireless connection, periodically, continually, or continuously, to receive information about items 130, such as the current price per unit of weight, from information system 160. Stationary intelligent weighing systems 200S may calculate the cost of weighed items 130 based on the weight and the price per unit of weight, and communicate the identifier, weight, price per unit of weight, and/or calculated cost to client application 152, without the need for scanner 140.

In an embodiment, stationary intelligent weighing system 200S may comprise a printer that prints a paper receipt with a barcode or other machine-readable indicium that encodes the weight, identity, and/or cost of items 130 weighed by stationary intelligent weighing system 200S. In this case, instead of pairing stationary intelligent weighing system 200S with scanner 140 or mobile device 150, the worker may simply scan the machine-readable indicium, which, when decoded, supplies the encoded information to client application 152.

Alternatively or additionally, stationary intelligent weighing system 200S could offer coupons (e.g., manufacturer coupons) or other incentives, which may be printed on the paper receipt or separately from the paper receipt. For example, if a worker weighs strawberries, stationary intelligent weighing system 200S could print a coupon for a particular brand of whipped cream.

The printer of stationary intelligent weighing system 200S may utilize a large capacity paper roll. Stationary intelligent weighing system 200S may be configured to detect when the paper roll is running low. When detecting that the paper roll is running low, stationary intelligent weighing system 200S may communicate with a third-party service provider (e.g., via network 170) to initiate replacement of the paper roll and/or request other forms of maintenance.

It should be understood that stationary intelligent weighing system 200S can be used independently of the disclosed intelligent electronic shopping system. In other words, other shoppers, besides PSDD workers, can utilize stationary intelligent weighing system 200S to weigh item(s) 130. In this case, a shopper may utilize stationary intelligent weighing system 200S to weigh item(s) 130. Stationary intelligent weighing system 200S may automatically identify the item(s) 130 or the shopper may manually input the identity of the item(s) 130 via input(s) 240. Then, stationary intelligent weighing system 200S may print out the paper receipt, which the shopper may utilize to purchase the weighed item(s) 130 at checkout.

In some instances, a produce item 130 may be priced by quantity, rather than weight. For example, apples are typically priced by pound, but avocados are typically priced by quantity. A worker or other shopper may not know this and attempt to weigh the produce item(s) 130. In this case, stationary intelligent weighing system 200S may prompt the shopper to input the quantity of item(s) 130 via input(s) 240 or the graphical user interface of client application 152 may prompt the worker to input the quantity of item(s) 130.

In an embodiment in which stationary intelligent weighing system 200S pairs with mobile device 150, display 230 may mirror or otherwise provide aspects of the graphical user interface provided by client application 152. In other words, the graphical user interface may be cast to display 230 on stationary intelligent weighing system 200S. In this case, the worker may utilize the graphical user interface on display 230 in the same manner as the worker would use the graphical user interface provided by client application 152 on mobile device 150. For example, the worker could assign the weighed item(s) 130 to a particular order via input(s) 240, which may be integrated with display 230 as a touch-panel display.

In an embodiment, stationary intelligent weighing system 200S comprises a cabinet 260, which may be opened and closed via one or more cabinet doors 265. Cabinet 260 may store a plurality of scanners 140, illustrated as scanners 140A, 140B, . . . , 140N. It should be understood that cabinet 260 may represent the fixed location, mentioned above, at which each worker may select a scanner 140.

When cabinet door(s) 265 are closed, cabinet 260 may be locked. In an embodiment, cabinet door(s) 265 may be unlocked via client application 152. For example, the lock on cabinet door(s) 265 may be paired with a mobile device 150 of the worker, using, for example, near-field communication (NFC) or a short-range wireless technology. Client application 152 may perform authentication with the paired lock (e.g., using an cryptographic key). When the authentication is successful, the lock may unlock, enabling the worker to access cabinet 260 and select a scanner 140.

When stored in cabinet 260, each scanner 140 may be supplied with power from a power source 270 within stationary intelligent weighing system 200S and/or cabinet 260. Power source 270 may comprise an electrical connection to a power grid (e.g., via an electrical cord and outlet). Alternatively or additionally, power source 270 may comprise a rechargeable battery. Scanners 140 may comprise rechargeable batteries that are charged via a wired connection between a charging port on each scanner 140 and power source 270 (e.g., via USB, docking station, or other connection) or inductive charging provided by shelves within cabinet 260.

In addition, when stored in cabinet 260, each scanner 140 may be communicatively coupled to information system 160 via a wired or wireless connection. In the case of a wired connection, the wired connection may be the same connection that is used for charging scanner 140 or may be a different connection than the connection that is used to charge scanner 140. Via this communicative coupling, information system 160 may communicate information (e.g., current prices) about items 130 to each scanner 140, provide software (e.g., firmware) updates to each scanner 140, and/or the like.

In an embodiment, each scanner 140 may comprise an RFID tag or machine-readable indicium. A worker may be required to check-out a scanner 140 at the beginning of a shopping trip using an RFID reader, optical device, or other scanning system, and check-in the scanner 140 at the end of the shopping trip using the same RFID reader, optical device, or other scanning system. Each check-in and check-out of a scanner 140 may be associated with a unique identifier of the worker, so that usage, and potentially the loss, of scanners 140 may be associated with particular workers.

In an embodiment, cabinet 260 may be separate from stationary intelligent weighing system 200S. In this case, cabinet 260 may exist on its own (i.e., without components 210, 220, 230, 240, and/or 250), and potentially be located in a different location than stationary intelligent weighing system 200S. For example, such a cabinet 260 could be placed at the front of the merchant's store, so that workers can select scanners 140 as soon as they enter the merchant's store. In embodiments in which portable intelligent weighing systems 200P are used, portable intelligent weighing systems 200P may similarly be stored, charged, and/or updated within cabinet 260.

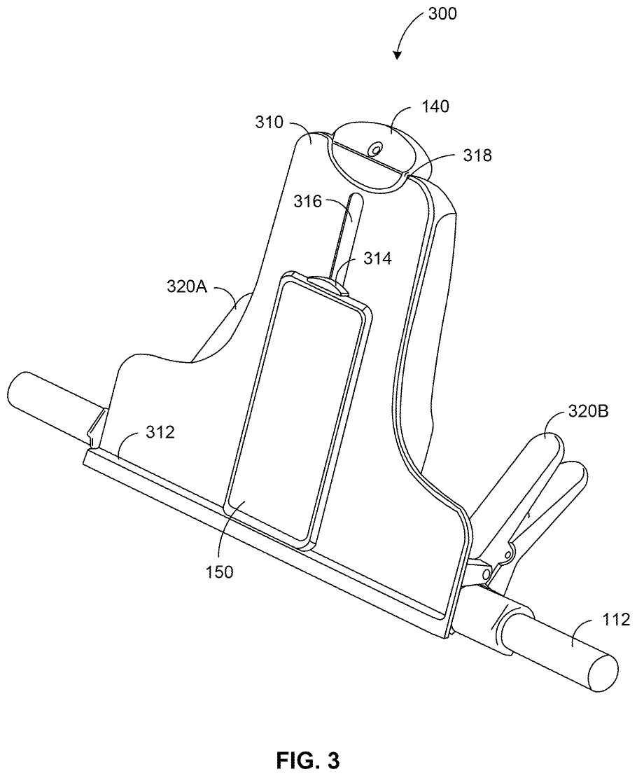

FIG. 3 illustrates a housing 300 for components of an intelligent electronic shopping system, according to an embodiment. Housing 300 provides a convenient system for stowing the worker's mobile device 150, as well as a scanner 140, in one place on a shopping cart 110. Housing 300 may be owned by worker, or may be provided by the merchant or a third party.

Housing 300 comprises a main body 310. Main body 310 may comprise a shelf 312 configured to hold a mobile device 150. Thus, a worker may set mobile device 150 on shelf 312. In addition, main body 310 may comprise a clamp 314 that is configured to slide along a track 316, orthogonally to shelf 312. With mobile device 150 seated on shelf 312, the worker may slide clamp 314 towards shelf 312 along track 316 until clamp 314 presses against the top of mobile device 150. In this manner, mobile device 150 can be clamped between shelf 312 and clamp 314, so as to be held in place on main body 310, regardless of the size of mobile device 150.

Main body 310 may be attached to one or more clips 320, illustrated as first clip 320A and second clip 320B. Each clip 320 may be biased towards a closed position by a spring, and configured to clip on a portion of frame 112 of shopping cart 110. Thus, a worker may easily attach housing 310 to frame 112 (e.g., at the start of a shopping trip), as well as detach housing 310 from frame 112 (e.g., at the end of the shopping trip).

In addition to holding mobile device 150, main body may comprise a socket 318 configured to receive a scanner 140. Socket 318 may be shaped and sized to match the shape and size of a portion of scanner 140, such that scanner 140 fits tightly within socket 318 and is held within socket 318 by a friction fit. When scanner 140 is not in use, the worker may stow scanner 140 within socket 318. Conversely, when the worker needs to use scanner 140, the worker may pull scanner 140 out of socket 318.

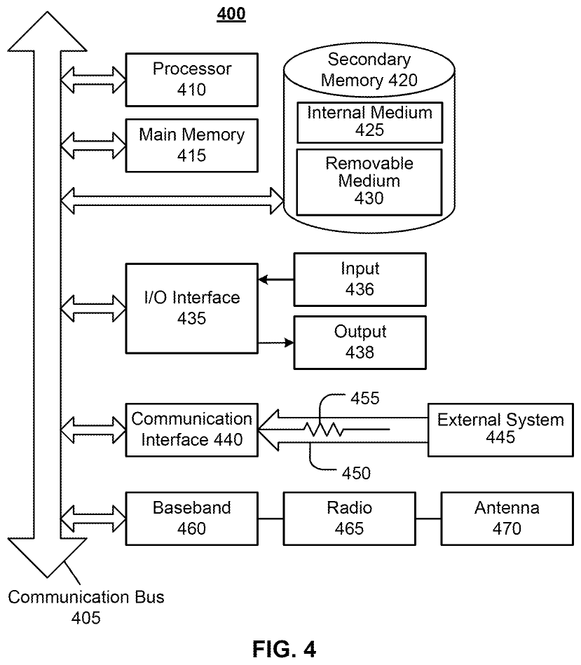

FIG. 4 illustrates an example processing system, by which one or more of the processes described herein may be executed, according to an embodiment. For example, system 400 may be used as or in conjunction with one or more of the functions or other processes (e.g., to store and/or execute the software application) described herein, and may represent components of scanner 140, mobile device 150, information system 160, ordering platform 180, user system 190, intelligent weighing system 200, and/or other processing devices described herein. System 400 can be any processor-enabled device (e.g., server, personal computer, etc.) that is capable of wired or wireless data communication. Other processing systems and/or architectures may also be used, as will be clear to those skilled in the art.

System 400 may comprise one or more processors 410. Processor(s) 410 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 410. Examples of processors which may be used with system 400 include, without limitation, any of the processors (e.g., Pentium™, Core i7™, Core i9™, Xeon™, etc.) available from Intel Corporation of Santa Clara, Calif., any of the processors available from Advanced Micro Devices, Incorporated (AMD) of Santa Clara, Calif., any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 410 may be connected to a communication bus 405. Communication bus 405 may include a data channel for facilitating information transfer between storage and other peripheral components of system 400. Furthermore, communication bus 405 may provide a set of signals used for communication with processor 410, including a data bus, address bus, and/or control bus (not shown). Communication bus 405 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 400 may comprise main memory 415. Main memory 415 provides storage of instructions and data for programs executing on processor 410, such as any of the software discussed herein, including the disclosed software application or one or more software modules within the disclosed software application. It should be understood that programs stored in the memory and executed by processor 410 may be written and/or compiled according to any suitable language, including without limitation C/C++, Java, JavaScript, Perl, Python, Visual Basic, .NET, and the like. Main memory 415 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 400 may comprise secondary memory 420. Secondary memory 420 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 400. The computer software stored on secondary memory 420 is read into main memory 415 for execution by processor 410. Secondary memory 420 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 420 may include an internal medium 425 and/or a removable medium 430. Removable medium 430 is read from and/or written to in any well-known manner. Removable storage medium 430 may be, for example, a magnetic tape drive, a compact disc (CD) drive, a digital versatile disc (DVD) drive, other optical drive, a flash memory drive, and/or the like.

System 400 may comprise an input/output (I/O) interface 435. I/O interface 435 provides an interface between one or more components of system 400 and one or more input devices 436 and/or output devices 438. Example input devices 436 include, without limitation, sensors, keyboards, touch screens or other touch-sensitive devices, cameras, biometric sensing devices, computer mice, trackballs, pen-based pointing devices, and/or the like. Examples of output devices 438 include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input device 436 and output device 438 may be combined, such as in the case of a touch-panel display (e.g., in scanner 140, mobile device 150, user system 190, or intelligent weighing system 200).

System 400 may comprise a communication interface 440. Communication interface 440 allows software to be transferred between system 400 and external systems, networks, or other information sources. For example, computer-executable code and/or data may be transferred to system 400 from a network server (e.g., information system 160, ordering platform 180, etc.) via communication interface 440. Examples of communication interface 440 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 400 with a network (e.g., network(s) 170) or another computing device. Communication interface 440 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 440 is generally in the form of electrical communication signals 455. These signals 455 may be provided to communication interface 440 via a communication channel 450 between communication interface 440 and an external system 445. In an embodiment, communication channel 450 may be a wired or wireless network (e.g., network(s) 170), or any variety of other communication links. Communication channel 450 carries signals 455 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 415 and/or secondary memory 420. Computer-executable code can also be received from an external system 445 via communication interface 440 and stored in main memory 415 and/or secondary memory 420. Such computer-executable code, when executed, enable system 400 to perform the various functions or other processes of the disclosed embodiments as described elsewhere herein.

In an embodiment that is implemented using software, the software may be stored on a computer-readable medium and initially loaded into system 400 by way of removable medium 430, I/O interface 435, or communication interface 440. In such an embodiment, the software is loaded into system 400 in the form of electrical communication signals 455. The software, when executed by processor 410, preferably causes processor 410 to perform one or more of the functions or other processes described elsewhere herein.

System 400 may comprise wireless communication components that facilitate wireless communication over a voice network and/or a data network (e.g., in the case of mobile device 150 and/or user system 190). The wireless communication components comprise an antenna system 470, a radio system 465, and a baseband system 460. In system 400, radio frequency (RF) signals are transmitted and received over the air by antenna system 470 under the management of radio system 465.

In an embodiment, antenna system 470 may comprise one or more antennae and one or more multiplexors (not shown) that perform a switching function to provide antenna system 470 with transmit and receive signal paths. In the receive path, received RF signals can be coupled from a multiplexor to a low noise amplifier (not shown) that amplifies the received RF signal and sends the amplified signal to radio system 465.

In an alternative embodiment, radio system 465 may comprise one or more radios that are configured to communicate over various frequencies. In an embodiment, radio system 465 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 465 to baseband system 460.

If the received signal contains audio information, then baseband system 460 decodes the signal and converts it to an analog signal. Then the signal is amplified and sent to a speaker. Baseband system 460 also receives analog audio signals from a microphone. These analog audio signals are converted to digital signals and encoded by baseband system 460. Baseband system 460 also encodes the digital signals for transmission and generates a baseband transmit audio signal that is routed to the modulator portion of radio system 465. The modulator mixes the baseband transmit audio signal with an RF carrier signal, generating an RF transmit signal that is routed to antenna system 470 and may pass through a power amplifier (not shown). The power amplifier amplifies the RF transmit signal and routes it to antenna system 470, where the signal is switched to the antenna port for transmission.

Baseband system 460 is communicatively coupled with processor(s) 410, which have access to memory 415 and 420. Thus, software can be received from baseband processor 460 and stored in main memory 410 or in secondary memory 420, or executed upon receipt. Such software, when executed, can enable system 400 to perform the various functions of the disclosed embodiments.

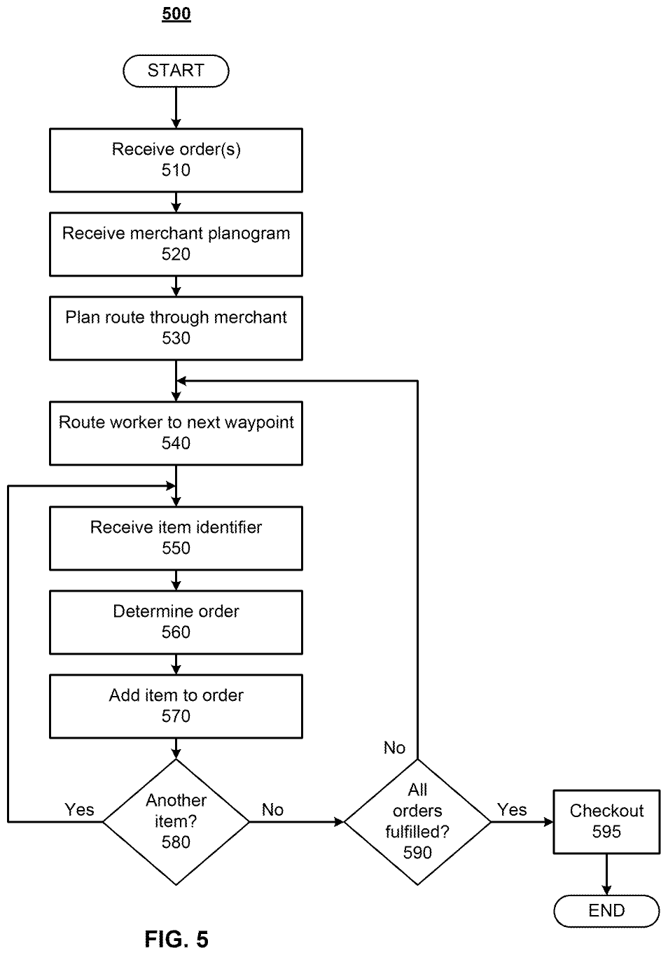

FIG. 5 illustrates an example process 500 that utilizes the intelligent electronic shopping system, according to an embodiment. Process 500 may be implemented by the disclosed software application, which may comprise one or more software modules that are executed by one or more hardware processors (e.g., processor 410). These software module(s) may be embodied entirely within client application 152, embodied entirely within server application 182, or distributed between client application 152 and server application 182. Process 500 may be implemented as instructions represented in source code, object code, and/or machine code. These instructions may be executed directly by hardware processor(s) 210, or alternatively, may be executed by a virtual machine operating between the object code and hardware processor(s) 210.

Alternatively, process 500 may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while process 500 is illustrated with a certain arrangement and ordering of subprocesses, process 500 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Initially, in subprocess 510, the software application will receive one or more orders that are specifically for a single merchant or which can all be fulfilled at a single merchant. These order(s) may be received from a client application 192 executing on one or more user systems 190. The order(s) for the given merchant may be dispatched to a single worker. For example, the order(s) may be provided to the worker via a dashboard in a graphical user interface of client application 152 executing on a mobile device 150 belonging to the worker. Each order will specify one or more items 130 to be purchased at the merchant's store. It should be understood that, while the primary benefits of the intelligent electronic shopping system will be obtained when there are multiple orders, process 500 works just as well with a single order.

After the order(s) have been dispatched to the worker, the worker may travel to the merchant's store. The worker may bring at least as many partitions 120 as the number of order(s), as well as mobile device 150, and optionally housing 300. When arriving at the merchant's store, the worker may select a shopping cart 110, mount partition(s) 120 within cart basket 114 of shopping cart 110, select a scanner 140 (e.g., from cabinet 260 at a fixed location within the merchant's store), pair mobile device 150 with scanner 140, and mount scanner 140 to frame 112 of shopping cart 110. In an embodiment in which housing 300 is used, housing 300 may be mounted to frame 112, and mobile device 150 and scanner 140 may be mounted in housing 300. In an embodiment in which mobile device 150 is used as the scanner, scanner 140 may be omitted. In an embodiment in which a portable intelligent weighing system 200P is used, the worker may select a portable intelligent weighing system 200P, pair mobile device 150 or scanner 140 with portable intelligent weighing system 200P, and mount portable intelligent weighing system 200P to frame 112 of shopping cart 110.

In an alternative embodiment, a merchant may provide a shopping cart 110 that already comprise partitions 120, scanner 140, and/or portable intelligent weighing system 200P. For example, the merchant's employees may preconfigure a subset of the merchant's shopping carts 110 in this manner (e.g., at the start of each day), and optionally disassemble these shopping carts 110 at the end of each day (e.g., and store the disassembled components in cabinet 260). In this case, the worker may simply select one of these preconfigured shopping carts 110 at the start of the shopping trip.

In subprocess 520, the software application may receive a planogram of the merchant's store. For example, client application 152 or server application 182 may retrieve the planogram from information system 160 or another system. The planogram may comprise a layout of the merchant's store (e.g., aisles, shelves, etc.) and identify the locations of all items 130 within the layout, such that the location of any item 130 in the order(s) can be easily retrieved from the planogram (e.g., using an identifier of the item 130). A typical grocery store may contain as many as 42,000 stock keeping units (SKUs). However, not all grocery stores have the same layouts. Thus, it should be understood that each planogram may be unique to a particular merchant's store.

In subprocess 530, the software application may plan a route through the merchant's store based on the locations of items 130, in the order(s) received in subprocess 510, as identified in the planogram received in subprocess 520. The route may be an optimal route that comprises a sequence of locations or “waypoints” and, for each waypoint in the sequence, a list of one or more items 130 to acquire at that waypoint. Optimization of the route (e.g., sequence of waypoints) may be based on one or more criteria, such as minimization of distance required to acquire all items 130, minimization of time required to acquire all items 130, and/or the like. It should be understood that, when multiple orders are received in subprocess 510, the route may be planned without having to segregate each order. For example, if two items 130 from different orders are located near each other within the layout, the route may include acquiring those two items 130 at the same time, despite being from different orders. Advantageously, the disclosed intelligent electronic shopping system enables the worker to keep the orders separate using partitions 120 and mobile device 150, even when collecting the orders simultaneously.

The software application may generate a graphical user interface, for display on mobile device 150 (e.g., via client application 152). The graphical user interface may display a representation of each of the order(s). Each representation of an order may be color-coded with a different color than any other order. In particular, each order that is dispatched to the worker and represented in the planned route may color-coded with a unique color (e.g., pastel color). Thus, a first order will be associated with a first color, and a second order will be associated with a second color that is different from the first color. In embodiments which utilize color-coded partitions 120, the color-coding of each partition 120 may match the color-coding of the order associated with that partition 120. The color-coding may be setup by the worker at the start of the shopping trip. In a graphical user interface, provided by client application 152 on a display (e.g., output 438) of mobile device 150, the color-coding may be used to color order-specific user-interface elements in the graphical user interface to visually differentiate a plurality of orders to be fulfilled by the worker.

In subprocess 540, the software application may route the worker to the next location in the planned route. For example, the software application may determine the current location of mobile device 150 using a global navigation satellite system (GNSS), such as the Global Positioning System (GPS), for which a GPS receiver may be installed within mobile device 150, and/or an indoor positioning system within the merchant's store. The software application may then determine an optimal path (e.g., shortest path) between the current location and the next waypoint in the sequence of waypoints in the planned route, based on the layout received in subprocess 520. The graphical user interface may display this path on a virtual map of the merchant's store, which may be generated based on the layout, display a sequence of navigational instructions representing the path in a narrative and/or directional form, and/or the like. More generally, the graphical user interface routes the worker through the sequence of waypoints. The path may be updated (e.g., in real time) as mobile device 150 moves through the merchant's store and recalculated whenever mobile device 150 diverges from the path. A pin may be provided on the virtual map at each waypoint within the sequence of waypoints on the path. The pins may be color-coded according to the order to which items 130 at the respective waypoint are associated. In an embodiment in which stationary intelligent weighing system 200S is utilized, a waypoint, representing the location of stationary intelligent weighing system 200S, may be inserted into the path whenever item(s) to be acquired along the path need to be weighed.

In subprocess 550, the software application may receive an identifier of an item 130. For example, once mobile device 150 has arrived at the next waypoint, client application 152 may display a list of one or more items 130 to be acquired at that waypoint, and/or prompt the worker to acquire one of the items 130 in the list of item(s) 130 to be acquired at the waypoint. The worker may utilize scanner 140 (or mobile device 150, when being used as the scanner) to identify an item 130 to the software application by scanning the machine-readable indicium (e.g., UPC) or reading an RFID tag on an item 130 in the list, or scanner 140 may identify item 130 using computer vision. Scanner 140 may provide the identifier to client application 152 on mobile device 150.

If an item 130 to be identified in subprocess 550 is the type of item 130 that needs to be weighed, the item or items 130 may be weighed using an intelligent weighing system 200. For example, the worker may weigh item(s) 130 using portable intelligent weighing system 200P. In an embodiment in which portable intelligent weighing system 200P is paired with mobile device 150, portable intelligent weighing system 200P may communicate the weight of item(s) 130 to client application 152, which may calculate the cost of item(s) 130 based on the weight and the price per unit of weight for item(s) 130 (e.g., received from information system 160 or scanner 140). In an alternative embodiment in which portable intelligent weighing system 200P is paired with scanner 140, portable intelligent weighing system 200P may communicate the weight of item(s) 130 to scanner 140, which may calculate the cost of item(s) 130 based on the weight and the price per unit of weight for item(s) 130 (e.g., received from information system 160) and/or communicate the cost and/or weight, along with an identifier of the item(s) 130, to client application 152.

Alternatively, the worker may weigh item(s) 130 using stationary intelligent weighing system 200S. In an embodiment in which stationary intelligent weighing system 200S is paired with mobile device 150, stationary intelligent weighing system 200S may communicate the weight of item(s) 130, and optionally the identifier of item(s) 130, as determined by computer vision system 250, to client application 152, which may calculate the price of item(s) 130 based on the weight and the price per unit of weight for item(s) 130 (e.g., received from information system 160, scanner 140, or stationary intelligent weighing system 200S). In an alternative embodiment in which stationary intelligent weighing system 200S is paired with scanner 140, stationary intelligent weighing system 200S may communicate the weight of item(s) 130, and optionally the identifier of item(s) 130, as determined by computer vision system 250, to scanner 140, which may calculate the cost of item(s) 130 based on the weight and the price per unit of weight for item(s) 130 (e.g., received from information system 160) and/or communicate the cost and/or weight, along with an identifier of item(s) 130, to client application 152.

In subprocess 560, the software application may determine which order is associated with the identifier received in subprocess 550. For example, the software application could match the scanned item 130 to an item in one of the orders, and automatically associate the scanned item 130 to that order. However, it may not always be possible to precisely match an identifier, such as a UPC, to particular items in the orders. Thus, in an alternative or additional embodiment, the worker may select the order to which to add the scanned item 130, either before or after scanning the item 130.

In particular, the graphical user interface provided by the software application on a display (e.g., output device 438) of mobile device 150 may provide a running total of all items 130 acquired for each order, and optionally, a list of items 130 remaining to be acquired (e.g., differentiated from acquired items 130). The list of items 130 in each order may be distinguished from the list of items 130 in other orders using the color-coding for each order. A virtual button may be provided, for each order, in the graphical user interface, in the color-coding for that order, so that the worker can easily switch between the orders. The virtual button may display one or more statistics for the order, such as the running total cost for all acquired items 130 in the order, the number of items 130 acquired for the order, the number of items 130 remaining to be acquired for the order, and/or the like. When a worker selects the virtual button for a particular order, the graphical user interface may display a detailed list of items 130 in the order, including, for each item 130, the product name, size, price, quantity, cost, image, and/or the like. Each item 130 in the detailed list may comprise one or more inputs for editing the item 130, such as deleting the item 130, changing a quantity of the item 130, and/or the like.

Prior to scanning item 130 in subprocess 550, the worker could select the virtual button associated with the order to which item 130 is to be associated. In this case, subprocess 560 may comprise determining which order is currently selected. Alternatively, after scanning item 130 in subprocess 550, the graphical user interface may prompt the worker to select an order. In this case, subprocess 560 may comprise determining which order is selected by the worker in response to the prompt.

In subprocess 570, the item 130, identified in subprocess 550, is added to the order determined in subprocess 560. In particular, the order, determined in subprocess 560, may be updated to reflect the addition of the scanned item 130. In addition, any statistics, such as the running total cost for all acquired items 130 in the order, the number of items 130 acquired for the order, the number of items 130 remaining to be acquired for the order, and/or the like, may be updated to reflect the addition of the scanned item 130.

The worker may physically place the item 130, identified in subprocess 550, into the partition 120 associated with the order, determined in subprocess 560. The graphical user interface may prompt or otherwise guide the worker to place the scanned item 130 in the corresponding partition 120. In an embodiment, the partitions 120 may themselves be color-coded, in which case the graphical user interface may indicate the color of partition 120 into which the worker should place the scanned item 130.

A non-limiting, detailed example of an interaction with an intelligent weighing system 200 in subprocesses 550-570 will now be described. While it is contemplated that this example would primarily apply to an interaction with stationary intelligent weighing system 200S, it could similarly apply to an interaction with portable intelligent weighing system 200P.

Initially, intelligent weighing system 200 may automatically detect the presence of an intelligent electronic shopping system. For example, intelligent weighing system 200 may utilize a short-range wireless technology to automatically detect a scanner 140 or mobile device 150 entering the wireless range of intelligent weighing system 200. Alternatively, the worker may initiate a pairing of intelligent weighing system 200 with a scanner 140 or mobile device 150. For the purposes of this example, it will be assumed that intelligent weighing system 200 is designed to pair with mobile device 150. However, it should be understood that the example may be adapted for a pairing with scanner 140.

When detecting the presence of mobile device 150, display 230 of intelligent weighing system 200 may display a prompt to verify a pairing with mobile device 150. The worker may utilize input(s) 240 and/or the graphical user interface of the software application to verify the pairing. In this case, intelligent weighing system 200 will complete the pairing with the worker's mobile device 150. After the pairing, the graphical user interface may be displayed on the display of mobile device 150 or on display 230 of intelligent weighing system 200. Accordingly, it should be understood that any of the described interactions with the graphical user interface may occur through mobile device 150 or intelligent weighing system 200.

The worker may proceed to weigh a set of one or more items 130 on intelligent weighing system 200, which may determine the identity and weight of item(s) 130, corresponding to subprocess 550. After the weighing, the graphical user interface may display information, such as the identity, weight, price per weight, and/or cost of item(s) 130. In addition, the graphical user interface may prompt the worker to accept the information. The worker may verify the correctness of the information via the graphical user interface (e.g., by selecting a confirmation input in the graphical user interface). In addition, the worker may select or verify the order to which the item(s) 130 are associated. The worker may select or verify the order via the graphical user interface (e.g., by selecting a color-coded virtual button associated with the order or selecting a confirmation input in the graphical user interface), corresponding to subprocess 560. The software application then adds the weighed item(s) 130, along with their cost, to that order. This step corresponds to subprocess 570. Finally, the worker may place the weighed item(s) 130, which have now been associated with an order, in the partition 120 associated with that order.

In subprocess 580, process 500 determines whether or not another item 130 remains to be acquired at the current waypoint. When another item 130 remains to be acquired at the current location of mobile device 150 (i.e., “Yes” in subprocess 580), process 500 may return to subprocess 550 to, for example, prompt the worker to scan (and/or weigh) the next item 130 in the list of items 130 to be acquired at the location. On the other hand, when no more items 130 remain to be acquired at the current waypoint (i.e., “No” in subprocess 580), process 500 proceeds to subprocess 590.

It should be understood that, by virtue of subprocess 580, a loop of subprocesses 550-570 may be performed at each waypoint in the sequence of waypoints through which the worker is being routed. In particular, at each waypoint in the sequence of waypoints and for each item 130 in the order(s) that is located at that waypoint, an identifier of the item 130 may be received, an order with which the item 130 is associated may be determined, and the item 130 may be added to the determined order. These subprocesses may be guided by prompts, which may be incorporated into the navigational instructions provided in the graphical user interface. These navigational instructions may even guide the worker as to which partition 120 (e.g., via color, number, or other identifier) to place each item 130. Thus, the worker simply needs to follow the navigational instructions to successfully fulfill all of the orders.

In an embodiment, during the loop of subprocesses 550-570, the graphical user interface of the software application may provide one or more inputs by which the worker can capture a real-time image of an item 130, and send that real-time image (e.g., as a still image or video) to the consumer, associated with the order with which the item 130 is associated, for approval. The graphical user interface provided at user system 190 may display the real-time image and provide one or more inputs for the consumer to submit the approval. For example, in the context of a grocery store, the worker could capture and send a real-time image of a fruit, vegetable, or cut of meat. The consumer may view the real-time image to determine whether or not the fruit or vegetable is sufficiently ripe, the cut of meat is of sufficient quality, or the like, and if so, provide approval via the input of the graphical user interface.

In an embodiment, during the loop of subprocesses 550-570, the graphical user interface of the software application may provide one or more inputs by which the worker can chat with the consumer in real time. For example, a chat box may be provided in the graphical user interfaces on both mobile device 150 and user system 190. Thus, the worker may ask the consumer who requested a particular order about substitutions of an item 130 (e.g., if the desired item 130 is not available, to take advantage of an offer, etc.) or any other issue that might arise during the shopping trip.

In subprocess 590, process 500 determines whether or not all orders have been fulfilled. In particular, the software application may determine whether or not every item 130 in every order has been acquired (i.e., added to the appropriate order in subprocess 570). When at least one order remains to be fulfilled (i.e., “No” in subprocess 590), process 500 returns to subprocess 540 to route the worker to the next waypoint in the sequence of waypoints in the route, planned in subprocess 530. On the other hand, when all orders have been fulfilled (i.e., “Yes” in subprocess 590), process 500 proceeds to subprocess 595.

In subprocess 595, the worker may checkout all orders via the software application. For example, the worker may utilize the graphical user interface of client application 152 to complete a checkout for all orders that were received in subprocess 510. This checkout may include payment for all of the items 130 in all of the orders. Payment may be made or facilitated via ordering platform 180. For each order, a first portion of the payment may be disbursed to the merchant, a second portion of the payment may be disbursed to an operator of ordering platform 180, and a third portion of the payment may be disbursed to the worker. However, from the consumer's perspective, a single payment may be made to ordering platform 180 or the merchant, and this single payment may be disbursed to the various parties on the back end, without specific visibility to the consumer.

In an embodiment, each order may be associated with different checkout settings, including different payment methods (e.g., credit or debit card numbers, bank accounts, other financial accounts, etc.), which may be specified by consumers via ordering platform 180. These checkout settings may be automatically applied to the orders when the worker performs the checkout, such that the worker does not need to have visibility as to the checkout settings.

In an embodiment, in subprocess 595, the software application may connect to the merchant's point-of-sale system to process the payment method specified for each order. In this case, the worker may not need to go through a checkout line. Rather, the worker can perform the checkout for all orders via the software application. In an embodiment, the worker can perform this checkout by selecting one or more, and preferably a single, input in the graphical user interface of the software application. In an alternative embodiment, the checkout may be automatically performed when mobile device 150 leaves the merchant's store (e.g., as determined by GPS or other positioning system). In this case, the worker simply needs to walk out of the merchant's store with mobile device 150 in order to complete subprocess 595.

In an embodiment, subprocess 595 may incorporate any applicable coupons, promotions, discounts, or other offers. These offers may be provided by the merchant, ordering platform 180, a consumer (e.g., by submitting a coupon with an order), and/or the like. For example, the merchant may offer a volume discount starting after a threshold quantity of a particular item 130 is purchased. If the quantity of that item 130, across all orders fulfilled during a single shopping trip, exceeds that threshold quantity, the volume discount may be automatically applied during subprocess 595.

After subprocess 595, the worker may load all of the orders into the worker's vehicle. For example, the worker may lift each partition 120 out of shopping cart 110 and place the partition 120, including all items 130 in the partition 120, which represent a single order, into the worker's vehicle. Alternatively, the worker may package all of the items 130 in each partition 120 into other respective packaging for delivery to the respective consumers. The worker may complete each order by delivering the order to the respective consumer.

In an embodiment, the software application may be gamified to incorporate mini-games for workers and/or consumers. For instance, the software application may enable competitions between the plurality of workers that utilizes the software application. Examples of competitions may include fastest shopping trip, most orders fulfilled during one shopping trip, best discounts unlocked, highest consumer satisfaction, and/or the like. The software application could provide a leaderboard via the graphical user interface, which ranks the highest scoring workers in each competition.

Advantageously, the disclosed intelligent electronic shopping system enables any conventional shopping cart 110 to be transformed into a smart cart. In particular, partitions 120, scanner 140, and/or portable intelligent weighing system 200P may be added to a standard shopping cart 110, to operate in conjunction with the worker's mobile device 150. This is in contrast to prior art smart carts, which utilize inflexible built-in components, can cost up to $10,000 per smart cart, and whose use must be strictly guarded (e.g., prohibiting removal from the merchant's store).

In addition, the disclosed intelligent electronic shopping system enables a plurality of orders to be efficiently completed simultaneously. In particular, partitions 120 and the disclosed graphical user interface, which may utilize specific prompts and navigational instructions, ensures that orders remain segregated and processed discretely, by reducing or eliminating opportunities for human error by PSDD workers.

Furthermore, the intelligent electronic shopping system may incorporate intelligent weighing systems 200 to allow for items 130 that are priced by weight and/or computer vision (e.g., in scanners 140 or computer vision system 250) to recognize items 130 without requiring a worker to key in the names of items 130. Such features are especially beneficial in the context of grocery stores, where items 130, such as fresh produce, disrupt conventional shopping methods.

The disclosed intelligent electronic shopping system also facilitates checkout of multiple orders. In embodiments, the checkout of all orders can be performed via a single input or automatically without any worker input. Thus, PSDD workers can completely avoid checkout lines, resulting in significant reductions in time and labor costs, as well as higher throughput and revenue.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents

A, B, and/or C. For example, a combination of A and B may comprise one A and multiple B's, multiple A's and one B, or multiple A's and multiple B's.

1. A system comprising:
a plurality of partitions, wherein each of the plurality of partitions is configured to hold a plurality of items and be mounted in a basket of a shopping cart;
one or more scanners, wherein each of the one or more scanners is configured to
pair with a mobile device,
determine an identifier of each of the plurality of items, and
communicate the identifier of each respective item to the mobile device via the pairing.

2. The system of claim 1, wherein determining the identifier of each of the plurality of items comprises, for each of the plurality of items:
reading a machine-readable indicium on the item; and
decoding the machine-readable indicium into an identifier of the item.

3. The system of claim 1, further comprising an information system, wherein each of the one or more scanners is further configured to:
receive information about each of the plurality of items from the information system; and
communicate the information about the respective item, with the identifier of the respective item, to the mobile device via the pairing.

4. The system of claim 3, wherein the information about the respective item comprises a price of the respective item.

5. The system of claim 1, wherein each of the one or more scanners is configured to detachably attach to a frame of the shopping cart.

6. The system of claim 1, further comprising a housing, wherein the housing comprises:
a shelf configured to hold a mobile device; and
a socket configured to hold at least one of the one or more scanners.

7. The system of claim 6, wherein the housing further comprises a clamp configured to slide along a track, orthogonally to the shelf, to thereby clamp the mobile device between the shelf and the clamp.

8. The system of claim 1, further comprising at least one intelligent weighing system, wherein the at least one intelligent weighing system is configured to:
pair with the mobile device;
weigh one or more of the plurality of items; and
communicate the weight of the one or more items to the mobile device via the pairing between the intelligent weighing system and the mobile device.

9. The system of claim 8, wherein the at least one intelligent weighing system comprises one or more portable intelligent weighing systems.

10. The system of claim 9, wherein each of the one or more portable intelligent weighing systems is configured to detachably attach to a frame of the shopping cart.

11. The system of claim 8, wherein the at least one intelligent weighing system comprises a stationary intelligent weighing system, and wherein the stationary intelligent weighing system comprises a holding surface, configured to hold one or more of the plurality of items, and a computer vision system that is configured to:
capture an image of the one or more items held on the holding surface;
apply a classification model to the captured image to determine a class of the one or more items in the captured image; and
communicate an identifier of the one or more items, derived from the determined class, to the mobile device via the pairing between the intelligent weighing system and the mobile device.

12. The system of claim 1, further comprising a software application configured to, when executed by at least one hardware processor:
receive a plurality of orders, to be fulfilled at a single merchant and dispatched to a single worker, via an ordering platform, wherein each of the plurality of orders comprises one or more of the plurality of items;
receive a planogram of the merchant's store, wherein the planogram comprise a layout of the merchant's store and identifies locations of the items in the plurality of orders;
plan a route through the merchant's store, based on the locations of the items in the plurality of orders, identified in the planogram, wherein the route comprise a sequence of waypoints in the merchant's store;
generate a graphical user interface, for display on the mobile device, that routes the worker through the sequence of waypoints; and
at each waypoint in the sequence of waypoints, for each item in the plurality of orders that is located at that waypoint,
receive an identifier of the item,
determine one of the plurality of orders with which the item is associated, and
add the item to the determined order.

13. The system of claim 12, wherein the software application comprises a client application, configured to execute on the mobile device.

14. The system of claim 12, wherein the software application comprises a server application, configured to transmit the graphical user interface to the mobile device.

15.-20. (canceled)
